(19) United States
(12) Patent Application Publication
(10) Pub. No.: US 2019/0122242 A1
(43) Pub. Date: Apr. 25, 2019

(54) DECREASING DIGITAL CONSUMPTION

(71) Applicant: Gregory Salzenstein, San Diego, CA (US)

(72) Inventor: Gregory Salzenstein, San Diego, CA (US)

(21) Appl. No.: 16/169,942

(22) Filed: Oct. 24, 2018

Related U.S. Application Data
(60) Provisional application No. 62/576,794, filed on Oct. 25, 2017.

(51) Int. Cl. G06Q 30/02; H04L 29/08

(52) U.S. Cl. CPC G06Q 30/0215; G06Q 30/0236; G06Q 30/0235; H04L 67/22

(57) ABSTRACT

A challenger may challenge a recipient to reduce digital consumption. The challenger may create a challenge including criteria and a reward. A monitoring application on a recipient device may record digital consumption history. A challenge system may determine whether the digital consumption history meets the challenge criteria. The challenge system may instruct a reward system to transfer the reward to the recipient.

### CROSS-REFERENCE TO RELATED APPLICATIONS

This application claims priority to and the benefit of U.S. Provisional Application No. 62/576,794 filed on Oct. 25, 2017. The aforementioned application is incorporated herein by reference in its entirety for all purposes.

### FIELD

The present disclosure relates to digital technology, and more particularly to integrating multiple systems to reduce consumption of digital technology.

### BACKGROUND

Digital technology, often in the form of social media applications, websites, blogs, etc., has experienced a dramatic rise in usage in recent years. The use of digital technology in large quantities by individuals has created distractions which may damage interpersonal relationships, cause decreased productivity at work and school, and led to harmful digital addictions among some individuals. Many digital applications are specifically designed to be addictive and encourage increased usage. Thus, it is difficult for an individual or organization to convince an individual to decrease their consumption of digital technology, even when such consumption may be occurring at harmful levels.

### SUMMARY

A system, method, and computer readable medium (collectively, “system”) for reduction of digital consumption is disclosed. The system may perform operations comprising receiving, from a challenger device, a challenge comprising criteria and a reward; transmitting, to a recipient device, a notification of the challenge; retrieving, from a monitoring system, digital consumption history for the recipient device; determining, based on the digital consumption history, that the criteria have been met; and transmitting an instruction to a reward system.

In various embodiments, the reward system may comprise a payment system. The challenge criteria may include one of a percentage reduction in consumption history, an applicable time and duration, or a specific digital consumption. In various embodiments, the specific digital consumption comprises one of an application opening count, an SMS message count, a call timer, an access code count, an email account opening count, or a streaming media count. The notification of the challenge may comprise an account registration prompt. In various embodiments, the system may receive a revised challenge criteria or a revised reward.

The foregoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may be obtained by referring to the detailed description and claims when considered in connection with the drawing figures, wherein like numerals denote like elements.

FIG. 1 illustrates various system components of a system for reducing digital consumption, in accordance with various embodiments;

FIG. 2 illustrates a flowchart of a process for reducing digital consumption, in accordance with various embodiments;

FIG. 3 illustrates a process flow for a user journey in a system for decreasing consumption of digital technology, in accordance with various embodiments; and

FIG. 4 illustrates a challenge details screen of a system for decreasing consumption of digital technology, in accordance with various embodiments.

### DETAILED DESCRIPTION

The detailed description of various embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

A first user may wish to incentive a second user to decrease consumption of mobile technology. For example, an employer may wish to decrease its employee's usage of social media during business hours. The first user may input challenge criteria to a challenge system. The challenge system may include, for example, a mobile application on a mobile device. The challenge criteria may include a goal for the second user, such as to use less than 30 minutes of social media during business hours each day for a week. The challenge criteria may include a reward, such as a $50 bonus each week that that challenge criteria are met.

The challenge criteria may be transmitted to the second user. The second user may elect accept the challenge criteria. A monitoring application on the second user's device may track the second user's digital consumption. If the criteria are met, the challenge system may instruct a peer-to-peer payment system to transmit the reward to the second user.

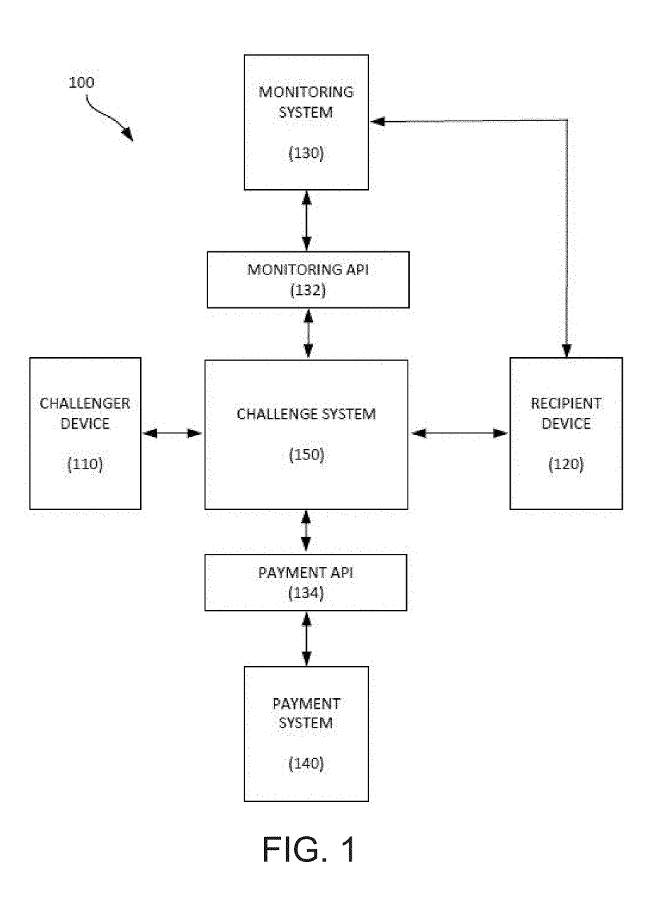

Referring to FIG. 1, a system 100 for decreasing consumption of digital technology is illustrated according to various embodiments. The system 100 may comprise a challenger device 110. The challenger device 110 may comprise any device capable of communicating with other devices over a network, such as a mobile phone, tablet, computer, etc. The challenger device 110 may be capable of transmitting a challenge comprising challenge criteria and a reward to a recipient device 120. The recipient device 120 may comprise any device capable of communicating with other devices over a network, such as a mobile phone, tablet, computer, etc. Any of these components may be outsourced and/or be in communication with system 100 via a network.

The recipient device 120 may comprise a monitoring application. The monitoring application may comprise software and/or hardware residing on the recipient device 120. The monitoring application may be capable of monitoring and storing data related to digital consumption on the recipient device 120. Various monitoring applications are known in the art, such as Moments™, Forest™, MySpy™, and PocketPoints™. The recipient device 120 may comprise a challenge application. The challenge application may comprise software and/or hardware residing on the recipient device 120. The challenge application may be capable of receiving a challenge comprising challenge criteria and a reward. The challenge application may be capable of storing the challenge criteria and the reward, and comparing the challenge criteria to data stored by the monitoring application.

The system 100 may comprise a monitoring system 130, a reward system such as, for example, payment system 140, and a challenge system 150. The monitoring system 130, the payment system 140, and the challenge system 150 may each comprise one or more servers or databases capable of processing and/or storing data. The monitoring system 130 may receive and store monitoring data regarding digital consumption on the recipient device 120. In various embodiments, a reward system may include a network capable of transferring rewards between system users such as, for example, a partner discount (e.g., a future discount at one or more loyalty partners, a retroactive discount at one or more of the loyalty partners, etc.), a loyalty point payout (e.g., 500 loyalty points), a loyalty partner credit (e.g., a credit applied to a user's transaction account), and/or virtual asset The reward system may include a payment system 140 which may be a network capable of transferring funds between financial accounts. Payment systems are well known in the art, such as PayPal™, Venmo™, Zelle™, Mech Link™, etc.

The challenge system 150 may receive a challenge from the challenger device 110. The challenge system 150 may store the challenge criteria and the reward associated with the challenge. The challenge system 150 may transmit the challenge to the recipient device. The challenge system 150 may communicate with the monitoring system 130 via a monitoring application programming interface (“API”) 132. The monitoring API 132 may allow the challenge system 150 to retrieve monitoring information from the monitoring system 130. The challenge system 150 may communicate with the payment system 140 via a payment API 134. The payment API 134 may allow the challenge system to instruct the payment system 140 to transfer funds in response to a recipient meeting the challenge criteria. In various embodiments, the challenge system 150 may be configured as a central network element or hub to access various systems, engines, and components of system 100. Challenge system 150 may comprise a network, computer-based system, and/or software components configured to provide an access point to various systems, engines, and components. Challenge system 150 may be in operative and/or electronic communication with challenger device 110, recipient device 120, payment API 134, payment system 140, monitoring API 132, and/or monitoring system 130.

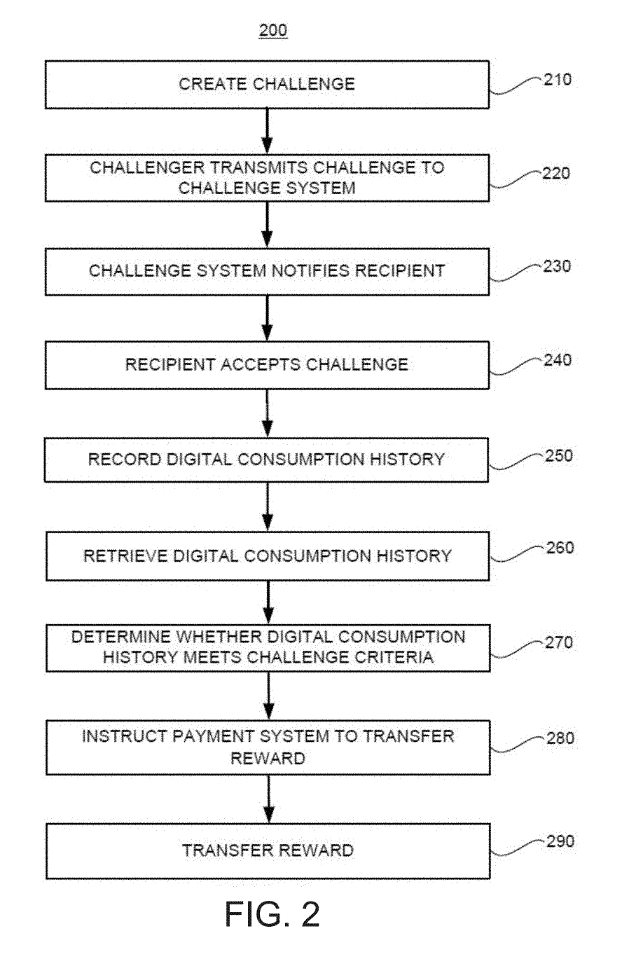

Referring to FIG. 2, a flowchart of a process 200 for decreasing consumption of digital technology is illustrated according to various embodiments. A challenger may create a challenge (step 210). The challenge may comprise criteria and a reward. The challenge criteria may describe a particular reduction in digital consumption on a recipient device. In various embodiments, the reduction may be defined as a percentage reduction in previous consumption over a specified timeframe, such as a 20% reduction in digital consumption compared to the previous week. In various embodiments, the reduction may be defined as a fixed amount, such as less than 2 hours of digital consumption per day. The criteria may comprise an applicable time and duration. The applicable time may indicate during what time the digital consumption should be decreased. For example, the applicable time may be 9:00 AM through 5:00 PM Monday through Friday. In various embodiments, the applicable time may be twenty-four hours per day. The duration may indicate how long the challenge will last. For example, the challenger may choose to challenge a recipient for one day, one week, or any other timeframe. In various embodiments, the challenge may be recurring, such that the recipient may earn a reward each day or other timeframe that they meet the challenge criteria.

The criteria may describe the particular digital consumption to be reduced. For example, the challenger may indicate that all digital consumption on the recipient device should be reduced. However, the challenger may select a more specific digital consumption to be reduced, such as consumption of a social media application, consumption of a video game, internet browsing, number of SMS messages (i.e., text messages), time on phone calls (i.e., a call timer), video watching (e.g., a streaming media count), number of times an application is opened, number of times an access code is entered, number of times an email account is opened etc.

The challenger may specify the reward. In various embodiments, the reward may comprise a financial reward. For example, the reward may comprise a currency amount, such as $10 for meeting the challenge criteria. In various embodiments, the challenger may create a custom reward and enter the custom reward into a custom reward field, such as taking the recipient to dinner at a particular restaurant if the recipient meets the challenge criteria. Various types of rewards may be included, such as charitable contributions, specific products or services, time off work, etc.

The challenger may specify one or more recipients. For example, the challenger may enter a phone number, user ID, email address, physical address, or any other information which specifies a recipient. In various embodiments, the challenger may specify themselves as the recipient in order to incentivize a change in their own behavior.

The challenger may transmit the challenge to the challenge system (step 220). The challenge system may receive the challenge and store the criteria and reward in a database. The challenge system may transmit a notification of the challenge to the recipient device (step 230). In various embodiments, the challenge system may transmit the notification in an email, text message, phone call, or push notification. The challenge system may determine whether the recipient has an account with the challenge system. If the recipient does not have an account with the challenge system, the notification may include an account registration prompt comprising a link to download the challenge application and/or register for an account.

The recipient may elect to accept the challenge (step 240). In various embodiments, the recipient may accept the challenge by clicking on a link or button. In various embodiments, the challenge may be automatically be applied, regardless of whether the recipient actively accepts the challenge. In various embodiments, the recipient may enter revised challenge criteria or a revised reward and transmit the revisions back to the challenger.

The monitoring application may record digital consumption history on the recipient device (step 250). In various embodiments, the monitoring application may record the digital consumption at all times. However, in various embodiments, the challenge system may instruct the monitoring system to only record digital consumption during the applicable time of the challenge.

The challenge system may retrieve the digital consumption history from the monitoring system (step 260). In various embodiments, the challenge system may retrieve the digital consumption history at the end of the duration of the challenge. However, in various embodiments, the challenge system may retrieve the digital consumption history continuously, or at any set interval, such as at 12:00 AM every day.

The challenge system may evaluate the digital consumption history to determine whether the recipient has met the challenge criteria (step 270). The challenge system may transmit a notification to the recipient and/or challenger which indicates whether the recipient met the challenge criteria. In various embodiments, the notification may include an invitation to renew the challenge, create a new challenge, or modify the existing challenge.

In response to the challenge criteria being satisfied, the challenge system may instruct the payment system to transfer the reward from a financial account of the challenger to the financial account of the recipient (step 280). In various embodiments, the payment system may temporarily remove the reward from the financial account of the challenger at the time the challenge is created to insure that the reward will be available for the recipient at the end of the duration of the challenge.

The payment system may transfer the reward from the financial account of the challenger to the financial account of the recipient (step 290). Thus, the recipient may receive the reward automatically after meeting the challenge criteria, without further action on the part of the challenger. However, in various embodiments the challenge system or the payment system may transmit a notification to the challenger that the criteria have been satisfied, and the challenger may verify that the payment system should transfer the funds to the recipient.

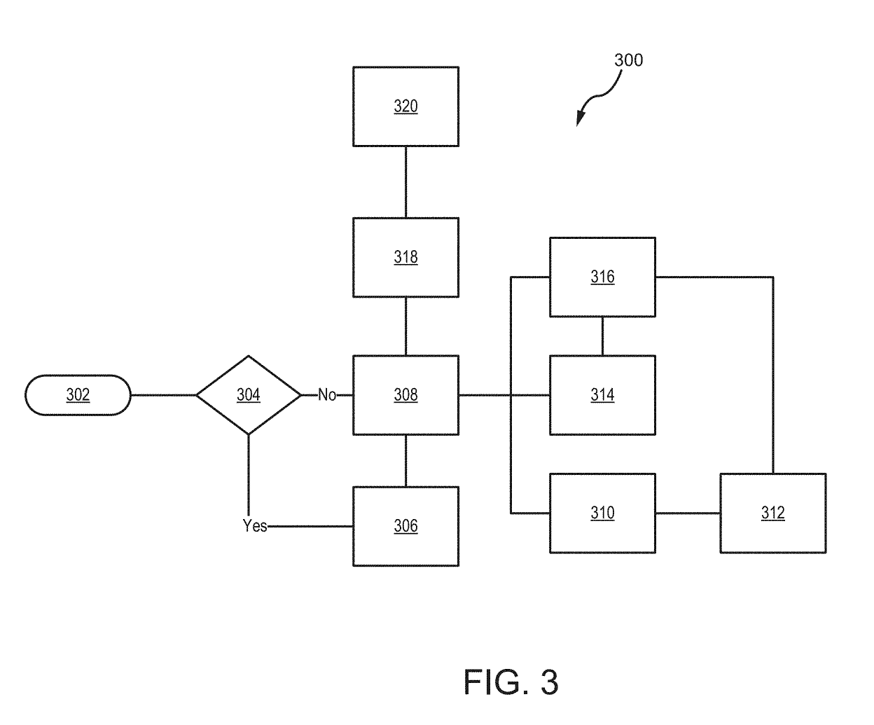

With additional reference to FIG. 3, a process flow 300 for a user journey in a system for decreasing consumption of digital technology is illustrated according to various embodiments. The user may access the system from a user device and the system may start a challenge system process in response to an access request (step 302). Step 302 may include receiving a command to launch a local process of a user device such as challenger device 110 or recipient device 120. Step 302 may include transmitting challenge data from the challenge system 150 to the user device in response to handshake data from the user device such as, for example, a user ID. The system may determine whether an active challenge is associated with the user ID (step 304). For example, step 304 may include the system searching for challenges associated with the user ID and returning all active challenges or a no-active challenges message where no active challenges are are associated with the user ID. In response to determining an active challenge, the system may display an active challenge details screen (step 306).

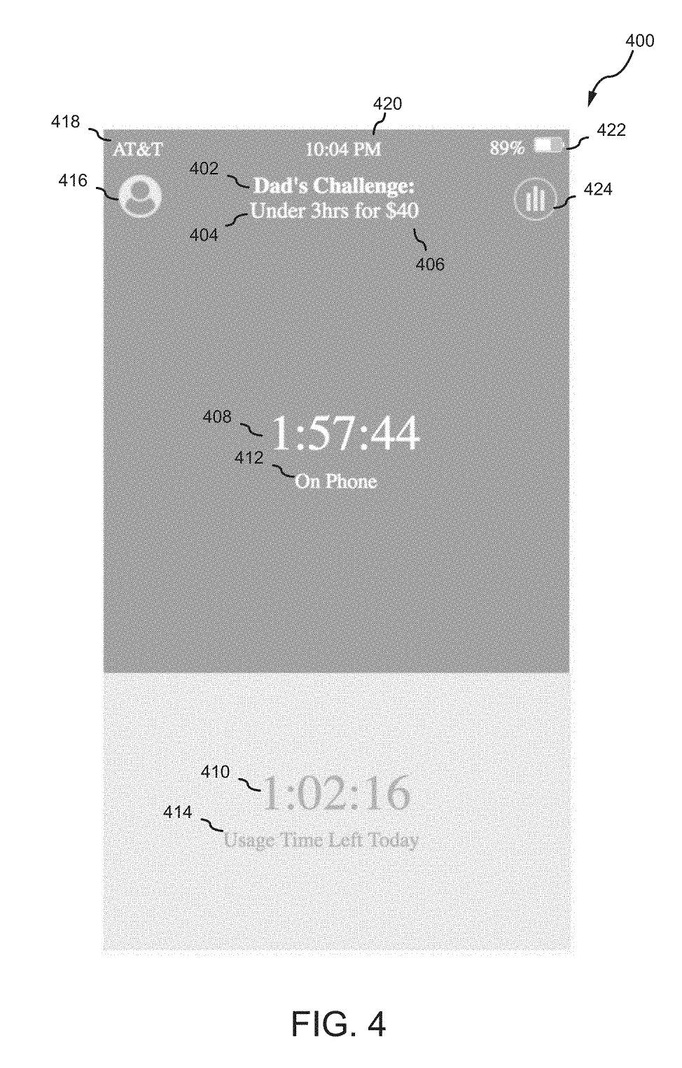

In various embodiments, and with brief additional reference to FIG. 4 an active challenge details screen 400 may include a plurality of challenge details of the active challenge. The challenge details may include a challenge name 402, a challenge criteria 404, and a reward 406. The details may include a consumption timer display which may include an elapsed time display 408 and a remaining time display 410. The challenge details may include a digital consumption target 412 and a discreet consumption window 414. The challenge details screen 400 may display a user avatar 416 which may be configured by a user and may display a challenge system status indictor 424. In various embodiments the challenge system status indicator 424 may display information about the challenge system or about the network connections between a user device and the challenge system. The challenge details screen 400 may display user device data such as, for example, a network provider 418, a local time 420, and a battery condition and capacity 422.

With reference again to FIG. 3, in response to determining no active challenges the system may display an all challenges screen (step 308). In various embodiments, the all challenges screen may display information of all challenges associated with a user ID. Each associated challenge may be represented by a plurality of tiles with each of the plurality of tiles displaying a subset of challenge information of the associated challenge. For example, each challenge tile may include a challenging user's avatar, a user ID, a challenge name, a challenge time, a reward, a time remaining indicator, a badge, etc. In various embodiments, The all challenges screen may include tile sorting features to sort the tiles into categories which may be defined by challenge criteria, reward criteria, active/inactive/completed challenges, user information, and/or any other criteria. The all challenges screen may include a navigation bar and the user may be able to navigate between one or more additional screens in response to a navigation request from the navigation bar. In various embodiments, the navigation bar may include a challenge creation action button which may generate a challenge creation command in response to a user interaction with the challenge creation button.

In response to a settings navigation request, the system may display a settings screen (step 310). In various embodiments, the settings screen may include one or more system settings or may include user information such as the user ID, password information, email address, and/or the like. In various embodiments, the settings screen may include the navigation bar, reward systems data, and rewards systems settings. In various embodiments, the settings screen may include one or more input fields. In various embodiments, the system may prompt the user to enter payment system information and may display a payment system setup screen (step 312). The payment system setup screen may include input fields for payment system data. In various embodiments step 312 may include a user device communicating with the payment system 140 via a payment API 134.

In various embodiments the system may display a challenge creation screen (step 314). Step 314 may include receiving a challenge creation command from the navigation bar. The challenge creation screen may include input fields for challenge criteria, rewards criteria, recipient ID, recipient name, challenge name, and/or the like. In various embodiments, the system may display a set challenges details screen (step 316). Step 316 may include displaying the set challenges details screen in response to the challenge creation command. Step 316 may include displaying the set challenges details screen in response to entering at least one of the recipient ID, recipient name, or challenge name. The set challenge details creation screen may include input fields for challenge criteria, rewards criteria, the particular digital consumption, and/or the like.

In various embodiments, the system may display a status overview screen (step 318). The system may display the status overview screen in response to a navigation command from the navigation bar. The status overview screen may display status information related to challenge data or challenge metadata. For example, the status overview screen may include graphical data of completed challenges over time, or may include total rewards earned per challenge criteria and/or the like. The system may display a stats day timeline (step 320).

The various functions described herein may be performed by the various system components. For example, the various monitoring functions may be performed by at least one of the challenger device, the challenge system, the monitoring system, the recipient device, or any cloud systems. Similarly, data, such as the challenge criteria, may be stored on at least one of the challenger device, the challenge system, the monitoring system, the recipient device, or any cloud systems.

The detailed description of various embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

Systems, methods and computer program products are provided. In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

As used herein, “satisfy,” “meet,” “match,” “associated with” or similar phrases may include an identical match, a partial match, meeting certain criteria, matching a subset of data, a correlation, satisfying certain criteria, a correspondence, an association, an algorithmic relationship and/or the like. Similarly, as used herein, “authenticate” or similar terms may include an exact authentication, a partial authentication, authenticating a subset of data, a correspondence, satisfying certain criteria, an association, an algorithmic relationship and/or the like.

Terms and phrases similar to “associate” and/or “associating” may include tagging, flagging, correlating, using a look-up table or any other method or system for indicating or creating a relationship between elements, such as, for example, (i) a transaction account and (ii) an item (e.g., offer, reward, discount) and/or digital channel. Moreover, the associating may occur at any point, in response to any suitable action, event, or period of time. The associating may occur at pre-determined intervals, periodic, randomly, once, more than once, or in response to a suitable request or action. Any of the information may be distributed and/or accessed via a software enabled link, wherein the link may be sent via an email, text, post, social network input and/or any other method known in the art.

The phrases individual, user, account holder, or the like shall include any person, entity, business, government organization, business, software, hardware, machine associated with a transaction account,

Examples of social media sites include FACEBOOK®, FOURSQUARE®, TWITTER®, MYSPACE®, LINKEDIN®, and the like. Examples of affiliate or partner websites include AMERICAN EXPRESS®, GROUPON®, LIVINGSOCIAL®, and the like. Moreover, examples of mobile device communications include texting, email, and mobile applications for smartphones.

The system may comprise a distributed network. The distributed network may comprise a distributed computing cluster configured for parallel processing and storage. The distributed computing cluster may comprise a plurality of nodes in electronic communication with each of the other nodes, as well as a control node. Processing tasks may be split among the nodes of the distributed computing cluster to improve throughput and enhance storage capacity. The distributed computing cluster may be, for example, a Hadoop® cluster configured to process and store big data sets with some of the nodes comprising a distributed storage system and some of the nodes comprising a distributed processing system.

In various embodiments, the nodes may comprise any devices capable of receiving and/or processing an electronic message via a network. For example, the nodes may take the form of a computer or processor, or a set of computers/processors, such as a system of rack-mounted servers. However, other types of computing units or systems may be used, including laptops, notebooks, hand held computers, personal digital assistants, cellular phones, smart phones (e.g., iPhone®, BlackBerry®, Android®, etc.) tablets, wearables (e.g., smart watches and smart glasses), or any other device capable of receiving data over the network.

In various embodiments, requests may be received by the control node. The control node may distribute the tasks among the nodes for processing to complete the job intelligently. The control node may thus limit network traffic and enhance the speed at which incoming data is processed. A network may be any suitable electronic link capable of carrying communication between two or more computing devices. For example, the network may be local area network using TCP/IP communication or wide area network using communication over the Internet. The nodes and control node may similarly be in communication with one another over the network. The network may be an internal network isolated from the Internet, or the network may comprise an external connection to enable direct electronic communication with the Internet.

A network may be unsecure. Thus, communication over the network may utilize data encryption. Encryption may be performed by way of any of the techniques now available in the art or which may become available—e.g., Twofish, RSA, El Gamal, Schorr signature, DSA, PGP, PKI, GPG (GnuPG), and symmetric and asymmetric cryptography systems.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., WINDOWS®, OS2, UNIX®, LINUX®, SOLARIS®, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations. Useful machines for performing the various embodiments include general purpose digital computers or similar devices.

In fact, in various embodiments, the embodiments are directed toward one or more computer systems capable of carrying out the functionality described herein. The computer system includes one or more processors, such as processor. The processor is connected to a communication infrastructure (e.g., a communications bus, cross over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Computer system also includes a main memory, such as for example random access memory (RAM), and may also include a secondary memory. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known manner. Removable storage unit represents a floppy disk, magnetic tape, optical disk, etc. which is read by and written to by removable storage drive. As will be appreciated, the removable storage unit includes a computer usable storage medium having stored therein computer software and/or data.

In various embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system.

Computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, etc. Software and data transferred via communications interface are in the form of signals which may be electronic, electromagnetic, optical or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

The terms “computer program medium” and “computer usable medium” and “computer readable medium” are used to generally refer to media such as removable storage drive and a hard disk installed in hard disk drive. These computer program products provide software to computer system.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components such as application specific integrated circuits (ASICs). Implementation of the hardware state machine so as to perform the functions described herein will be apparent to persons skilled in the relevant art(s).

In various embodiments, the server may include application servers (e.g. WEB SPHERE, WEB LOGIC, JBOSS). In various embodiments, the server may include application servers (e.g. APACHE, IIS, GWS, SUN JAVA® SYSTEM APPLICATION SERVER).

A web client includes any device (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, tablets, hand held computers, personal digital assistants, set-top boxes, workstations, computer-servers, main frame computers, mini-computers, PC servers, pervasive computers, network sets of computers, personal computers, such as IPADS®, IMACS®, and MACBOOKS®, kiosks, terminals, point of sale (POS) devices and/or terminals, televisions, or any other device capable of receiving data over a network. A web-client may run MICROSOFT® INTERNET EXPLORER®, MOZILLA® FIREFOX®, GOOGLE® CHROME®, APPLE® Safari, or any other of the myriad software packages available for browsing the internet.

Practitioners will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In various embodiments, access is through a network or the Internet through a commercially-available web-browser software package.

As those skilled in the art will appreciate, a web client includes an operating system (e.g., WINDOWS®/CE/Mobile, OS2, UNIX®, LINUX®, SOLARIS®, MacOS, etc.) as well as various conventional support software and drivers typically associated with computers. A web client may include any suitable personal computer, network computer, workstation, personal digital assistant, cellular phone, smart phone, minicomputer, mainframe or the like. A web client can be in a home or business environment with access to a network. In various embodiments, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp.

In various embodiments, components, modules, and/or engines of system 100 may be implemented as micro-applications or micro-apps. Micro-apps are typically deployed in the context of a mobile operating system, including for example, a WINDOWS® mobile operating system, an ANDROID® Operating System, APPLE® IOS®, a BLACKBERRY® operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., IPHONE®, BLACKBERRY®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, APPLE®talk, IP-6, NetBIOS®, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA® 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish Networks®, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/publications/nistpubs/800-145/SP800-145.pdf (last visited June 2012), which is hereby incorporated by reference in its entirety.

As used herein, “transmit” may include sending electronic data from one system component to another over a network connection. Additionally, as used herein, “data” may include encompassing information such as commands, queries, files, data for storage, and the like in digital or any other form.

The system contemplates uses in association with web services, utility computing, pervasive and individualized computing, security and identity solutions, autonomic computing, cloud computing, commodity computing, mobility and wireless solutions, open source, biometrics, grid computing and/or mesh computing.

Any databases discussed herein may include relational, hierarchical, graphical, blockchain, object-oriented structure and/or any other database configurations. Common database products that may be used to implement the databases include DB2 by IBM® (Armonk, N.Y.), various database products available from ORACLE® Corporation (Redwood Shores, Calif.), MICROSOFT® Access® or MICROSOFT® SQL Server® by MICROSOFT® Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure.

Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored in association with the system or external to but affiliated with system. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data, in the database or associated with the system, by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, the data set (e.g., BLOB) may be annotated in a standard manner when provided for manipulating the data in the database or system. The annotation may comprise a short header, trailer, or other appropriate indicator related to each data set that is configured to convey information useful in managing the various data sets. For example, the annotation may be called a “condition header,” “header,” “trailer,” or “status,” herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a standalone interaction device configured to add, delete, modify, or augment the data in accordance with the header or trailer. As such, in one embodiment, the header or trailer is not stored on the transaction device along with the associated issuer-owned data but instead the appropriate action may be taken by providing to the user at the standalone device, the appropriate option for the action to be taken. The system may contemplate a data storage arrangement wherein the header or trailer, or header or trailer history, of the data is stored on the system, device or transaction instrument in relation to the appropriate data.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

The computing units of the various devices may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of the system to further enhance security.

Firewall may include any hardware and/or software suitably configured to protect system components and/or enterprise computing resources from users of other networks. Further, a firewall may be configured to limit or restrict access to various systems and components behind the firewall for web clients connecting through an application server. Firewall may reside in varying configurations including Stateful Inspection, Proxy based, access control lists, and Packet Filtering among others. Firewall may be integrated within an application server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

The computers discussed herein may provide a suitable website or other Internet-based graphical user interface which is accessible by users. In one embodiment, the MICROSOFT® INTERNET INFORMATION SERVICES® (IIS), MICROSOFT® Transaction Server (MTS), and MICROSOFT® SQL Server, are used in conjunction with the MICROSOFT® operating system, MICROSOFT® NT application server software, a MICROSOFT® SQL Server database system, and a MICROSOFT® Commerce Server. Additionally, components such as Access or MICROSOFT® SQL Server, ORACLE®, Sybase, Informix MySQL, Interbase, etc., may be used to provide an Active Data Object (ADO) compliant database management system. In one embodiment, the Apache application server is used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® applets, JAVASCRIPT, active server pages (ASP), common gateway interface scripts (CGI), extensible markup language (XML), dynamic HTML, cascading style sheets (CSS), AJAX (Asynchronous JAVASCRIPT And XML), helper applications, plug-ins, and the like. A server may include a web service that receives a request from an application server, the request including a URL and an IP address (123.56.789.234). The application server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WEBSPHERE MQ™ (formerly MQSeries) by IBM®, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT, VBScript, Macromedia Cold Fusion, COBOL, MICROSOFT® Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “JAVA® Cryptography” by Jonathan Knudson, published by O'Reilly & Associates (1998); (3) “Cryptography & Network Security: Principles & Practice” by William Stallings, published by Prentice Hall; all of which are hereby incorporated by reference.

As will be appreciated by one of ordinary skill in the art, the system may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user WINDOWS®, webpages, websites, web forms, prompts, etc. Practitioners will appreciate that the illustrated steps described herein may comprise in any number of configurations including the use of WINDOWS®, webpages, web forms, popup WINDOWS®, prompts and the like. It should be further appreciated that the multiple steps as illustrated and described may be combined into single webpages and/or WINDOWS® but have been expanded for the sake of simplicity. In other cases, steps illustrated and described as single process steps may be separated into multiple webpages and/or WINDOWS® but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element is intended to invoke 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

In various embodiments, system components may be configured with a biometric security system that may be used for providing biometrics as a secondary form of identification. The biometric security system may include a transponder and a reader communicating with the system. The biometric security system also may include a biometric sensor that detects biometric samples and a device for verifying biometric samples. The biometric security system may be configured with one or more biometric scanners, processors and/or systems. A biometric system may include one or more technologies, or any portion thereof, such as, for example, recognition of a biometric. As used herein, a biometric may include a user's voice, fingerprint, facial, ear, signature, vascular patterns, DNA sampling, hand geometry, sound, olfactory, keystroke/typing, iris, retinal or any other biometric relating to recognition based upon any body part, function, system, attribute and/or other characteristic, or any portion thereof.

Phrases and terms similar to “account,” “transaction account,” “account number,” “account code” or “consumer account” as used herein, may include any device, code (e.g., one or more of an authorization/access code, personal identification number (“PIN”), Internet code, other identification code, and/or the like), number, letter, symbol, digital certificate, smart chip, digital signal, analog signal, biometric or other identifier/indicia suitably configured to allow the consumer to access, interact with or communicate with the system. The account number may optionally be located on or associated with a rewards account, charge account, credit account, debit account, prepaid account, telephone card, embossed card, smart card, magnetic stripe card, bar code card, transponder, radio frequency card or an associated account.

In various embodiments, the system and method may include alerting a subscriber when their computer is offline. The system may include generating customized information and alerting a remote subscriber that the information can be accessed from their device. The alerts are generated by filtering received information, building information alerts and formatting the alerts into data blocks based upon subscriber preference information. The data blocks are transmitted to the subscriber's wireless device which, when connected to a computer, causes the computer to auto-launch an application to display the information alert and provide access to more detailed information about the information alert. More particularly, the method may comprise providing a viewer application to a subscriber for installation on the remote subscriber computer; receiving information at a transmission server sent from a data source over the Internet, the transmission server comprising a microprocessor and a memory that stores the remote subscriber's preferences for information format, destination address, specified information, and transmission schedule, wherein the microprocessor filters the received information by comparing the received information to the specified information; generates an information alert from the filtered information that contains a name, a price and a universal resource locator (URL), which specifies the location of the data source; formats the information alert into data blocks according to said information format; and transmits the formatted information alert over a wireless communication channel to a wireless device associated with a subscriber based upon the destination address and transmission schedule, wherein the alert activates the application to cause the information alert to display on the remote subscriber computer and to enable connection via the URL to the data source over the Internet when the wireless device is locally connected to the remote subscriber computer and the remote subscriber computer comes online.

In various embodiments, the system may also include isolating and removing malicious code from electronic transmissions, such as the transmission of files between the mainframe network and the distributed network, or between nodes of the distributed network, to prevent a computer from being compromised, for example by being infected with a computer virus. The system may scan electronic communications for malicious computer code and clean the electronic communication before it may initiate malicious acts. The system operates by physically isolating a received electronic communication in a “quarantine” sector of the computer memory. A quarantine sector is a memory sector created by the computer's operating system such that files stored in that sector are not permitted to act on files outside that sector. When a communication containing malicious code is stored in the quarantine sector, the data contained within the communication is compared to malicious code-indicative patterns stored within a signature database. The presence of a particular malicious code-indicative pattern indicates the nature of the malicious code. The signature database further includes code markers that represent the beginning and end points of the malicious code. The malicious code is then extracted from malicious code-containing communication. An extraction routine is run by a file parsing component of the processing unit. The file parsing routine performs the following operations: scan the communication for the identified beginning malicious code marker; flag each scanned byte between the beginning marker and the successive end malicious code marker; continue scanning until no further beginning malicious code marker is found; and create a new data file by sequentially copying all non-flagged data bytes into the new file, which thus forms a sanitized communication file. The new, sanitized communication is transferred to a non-quarantine sector of the computer memory. Subsequently, all data on the quarantine sector is erased. More particularly, the system includes a method for protecting a computer from an electronic communication containing malicious code by receiving an electronic communication containing malicious code in a computer with a memory having a boot sector, a quarantine sector and a non-quarantine sector; storing the communication in the quarantine sector of the memory of the computer, wherein the quarantine sector is isolated from the boot and the non-quarantine sector in the computer memory, where code in the quarantine sector is prevented from performing write actions on other memory sectors; extracting, via file parsing, the malicious code from the electronic communication to create a sanitized electronic communication, wherein the extracting comprises scanning the communication for an identified beginning malicious code marker, flagging each scanned byte between the beginning marker and a successive end malicious code marker, continuing scanning until no further beginning malicious code marker is found, and creating a new data file by sequentially copying all non-flagged data bytes into a new file that forms a sanitized communication file; transferring the sanitized electronic communication to the non-quarantine sector of the memory; and deleting all data remaining in the quarantine sector.

What is claimed is:

1. A method comprising:
receiving, by a computer-based system and from a challenger device, a challenge comprising criteria and a reward;
transmitting, by the computer-based system and to a recipient device, a notification of the challenge;
retrieving, by the computer-based system and from a monitoring system, digital consumption history for the recipient device;
determining, by the computer-based system and based on the digital consumption history, that the criteria have been met; and
transmitting, by the computer-based system, an instruction to a reward system.

2. The method of claim 1, wherein the reward system comprises a payment system.

3. The method of claim 1, wherein the challenge criteria include one of a percentage reduction in consumption history, an applicable time and duration, or a specific digital consumption.

4. The method of claim 3, wherein the specific digital consumption comprises one of an application opening count, an SMS message count, a call timer, an access code count, an email account opening count, or a streaming media count.

5. The method of claim 1, wherein the notification of the challenge comprises an account registration prompt.

6. The method of claim 1, further comprising receiving, by the computer-based system and from the recipient device, one of a revised challenge criteria or a revised reward.

7. A system comprising:
a processor; and
a tangible, non-transitory memory configured to communicate with the processor, the tangible, non-transitory memory having instructions stored thereon that, in response to execution by the processor, cause the processor to perform operations comprising:
receiving, by the processor and from a challenger device, a challenge comprising criteria and a reward;
transmitting, by the processor and to a recipient device, a notification of the challenge;
retrieving, by the processor and from a monitoring system, digital consumption history for the recipient device;
determining, by the processor and based on the digital consumption history, that the criteria have been met; and
transmitting, by the processor, an instruction to a reward system.

8. The system of claim 7, wherein the reward system comprises a payment system.

9. The system of claim 7, wherein the challenge criteria include one of a percentage reduction in consumption history, an applicable time and duration, or a specific digital consumption.

10. The system of claim 9, wherein the specific digital consumption comprises one of an application opening count, an SMS message count, a call timer, an access code count, an email account opening count, or a streaming media count.

11. The system of claim 7, wherein the notification of the challenge comprises an account registration prompt.

12. The system of claim 7, further comprising receiving, by the processor and from the recipient device, one of a revised challenge criteria or a revised reward.

13. An article of manufacture including a non-transitory, tangible computer readable storage medium having instructions stored thereon that, in response to execution by a computer-based system, cause the computer-based system to perform operations comprising:
receiving, by the computer-based system and from a challenger device, a challenge comprising criteria and a reward;
transmitting, by the computer-based system and to a recipient device, a notification of the challenge;
retrieving, by the computer-based system and from a monitoring system, digital consumption history for the recipient device;
determining, by the computer-based system and based on the digital consumption history, that the criteria have been met; and
transmitting, by the computer-based system, an instruction to a reward system.

14. The article of manufacture of claim 13, wherein the reward system comprises a payment system.

15. The article of manufacture of claim 13, wherein the challenge criteria include one of a percentage reduction in consumption history, an applicable time and duration, or a specific digital consumption.

16. The article of manufacture of claim 15, wherein the specific digital consumption comprises one of an application opening count, an SMS message count, a call timer, an access code count, an email account opening count, or a streaming media count.

17. The article of manufacture of claim 13, wherein the notification of the challenge comprises an account registration prompt.

18. The article of manufacture of claim 13, further comprising receiving, by the computer-based system and from the recipient device, one of a revised challenge criteria or a revised reward.
